(19) United States
(12) Patent Application Publication
(10) Pub. No.: US 2016/0285352 A1
(43) Pub. Date: Sep. 29, 2016

(54) MAGNETIC BRAKE HAVING REDUCED-NOTCHING HYSTERESIS

(71) Applicant: SAGEM DEFENSE SECURITE, Boulogne-Billancourt (FR)

(72) Inventors: Bruno TILLY, Boulogne Billancourt (FR); Jerome PIATON, Boulogne Billancourt (FR)

(21) Appl. No.: 14/442,309

(22) PCT Filed: Nov. 15, 2013
(86) PCT No.: PCT/EP2013/073973

§ 371 Date: May 12, 2015

(30) Foreign Application Priority Data
Nov. 19, 2012 (FR) 12 03096

(51) Int. Cl. H02K 49/06

(52) U.S. Cl. CPC H02K 49/065

(57) ABSTRACT

A magnetic hysteresis brake includes a stator equipped with at least one control coil and a rotor mounted to be mobile facing poles of the stator, wherein the brake includes at least one magnet mounted on the stator facing the rotor and having a sufficient power to locally generate, in the rotor, a level of induction substantially equal to a maximum level of induction generated by the coil when the latter is powered.

### BACKGROUND OF THE INVENTION

1. Field of the Invention

The present invention relates to a magnetic hysteresis brake that can be used, for example, in the humane/machine interfaces to generate a force resisting the displacement of an object, such as a control instrument, manipulated by a user.

The resisting force concerned is the result of a magnetic friction exerted on a part linked to the object to be slowed down.

A magnetic hysteresis brake generally comprises a stator having poles, facing which a rotor is mounted to pivot. The rotor is made of a material with strong magnetic remanence and the stator is provided with means for generating a magnetic field to which the rotor is subjected so as to produce a resistance to the displacement of the rotor.

The rotor is linked to an instrument displaced by a user for example to control a device such as a motor. The magnetic field to which the rotor is subjected produces a resistance to the displacement of the rotor and therefore a resistance to the displacement of the instrument manipulated by the user.

2. Description of the Related Art

There are two types of brakes according to whether the friction obtained by the brake is constant or variable.

In the brakes with constant friction, the means generating the magnetic field are magnets generating a constant magnetic field. The invention does not relate to this type of brake.

In the brakes with controlled friction, the means generating the magnetic field are formed by a coil, the powering of which is controlled so as to vary the magnetic field produced. In the case of an instrument controlling an engine speed, this makes it possible, for example, to increase the resistance to the displacement of the instrument manipulated by the user as the engine speed increases or abruptly raise the resistance to the displacement of the control instrument when the speed of the engine departs from a predefined optimum operating range. This characteristic renders the brakes with controlled friction particularly advantageous notably in the field of human-machine interfaces.

However, these brakes with controlled friction exhibit a cogging torque that is prejudicial to the feedback felt by the user. Such a cogging torque is the result of an abrupt lowering of the excitation current circulating in the coil when the rotor is stopped. This abrupt lowering locally leaves a remanent field remaining in the rotor which opposes the displacement of the rotor over only a portion of its rotational movement, hence the perception of cogging by the user. This phenomenon does not appear when the lowering of current occurs when the rotor is moving, because this movement allows for a progressive cancellation of the remanent field over the entire circumference of the rotor.

Two solutions have been envisaged for resolving this problem. In the first, a weakly remanent material is used for the rotor. To obtain a predetermined friction, it is then necessary to increase the volume of the rotor and therefore the weight thereof, which is incompatible with certain applications, notably in the aeronautical field. In the second, a recommendation of use provides for always having to keep the rotor moving in the phases of reduction of the excitation of the friction brake. This amounts to imposing a movement on the user in particular circumstances when this movement can be unsuited to the control of the device in these circumstances.

When a cogging torque has appeared, the only way to eliminate it is to increase the excitation current to its maximum level and then lower it while keeping the rotor moving. Here again, these operations can be incompatible with a control of the device suited to the situation.

### BRIEF SUMMARY OF THE INVENTION

One aim of the invention is to provide a means for eliminating at least some of the above drawback.

To this end, there is provided, according to the invention, a magnetic hysteresis brake comprising a stator equipped with at least one control coil and a rotor mounted to be mobile facing poles of the stator. The brake comprises at least one magnet mounted on the stator facing the rotor and having a sufficient power to locally generate, in the rotor, a level of induction substantially equal to a maximum level of induction generated by the coil when the latter is powered.

Thus, when the excitation is abruptly stopped, the magnet will constitute a means for evening out the remanent field in the rotor.

Other features and advantages of the invention will emerge from reading the following description of particular, nonlimiting embodiments of the invention.

### BRIEF DESCRIPTION OF THE SEVERAL VIEWS OF THE DRAWING(S)

Reference will be made to the attached drawings, among which:

FIG. 1 is a schematic view of a brake according to the invention, in cross section along a plane containing the axis of rotation of the rotor,

FIG. 2 is a view in transversal cross section of this brake,

FIG. 3 is an enlarged detail view of portions of the rotor and of the stator facing one another.

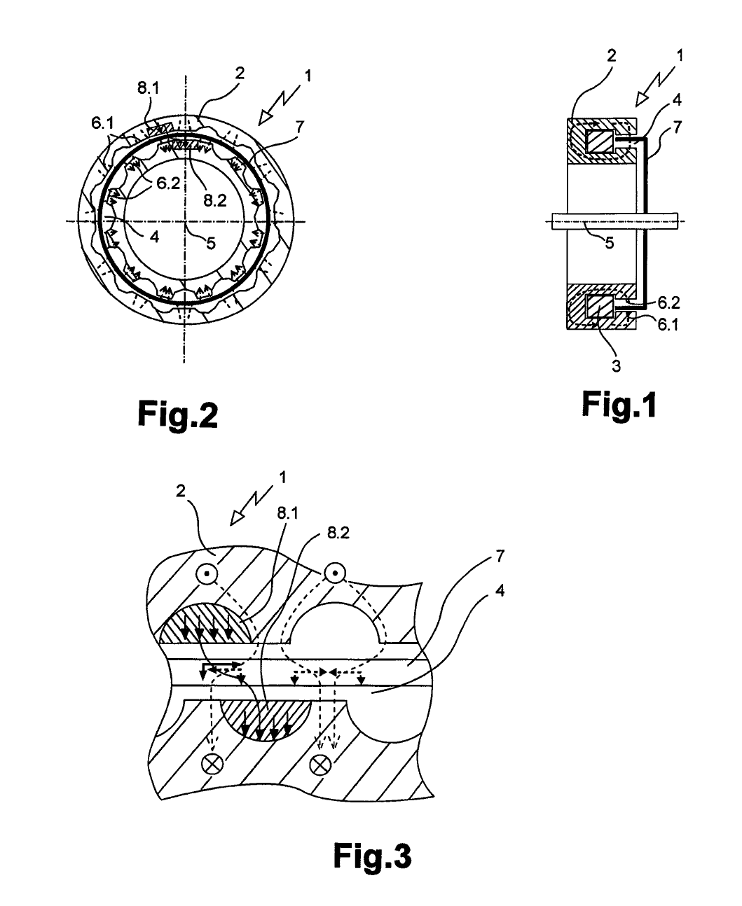

### DETAILED DESCRIPTION OF THE INVENTION

The brake according to the invention is described here in its application to a control instrument, such as a handle or a control column, intended to be manipulated by a user. The control instrument is, here, a pivoting lever.

Referring to the figures, the invention relates to a magnetic hysteresis brake, generally designated 1, comprising a stator 2 equipped with at least one control coil 3. The stator 2 comprises a keeper in which is formed a groove 4 of circular form and of central axis 5. The groove 4 has an outer flank and an inner flank which respectively exhibit reliefs forming poles 6.1, 6.2 of the stator 2. The poles 6.1 are angularly offset from the poles 6.2 such that each pole 6.1 is facing the space extending between two poles 6.2 adjacent to one another. The control coil 3 has a diameter close to that of the groove 4 and is mounted in the stator 2 coaxially to the groove 4 such that, when the control coil 3 is subjected to an excitation current, it generates magnetic fluxes passing from the poles 6.1 to the poles 6.2, or in the reverse direction, passing through the groove 4 in a non-radial direction. The control coil 3 is linked to a control unit, known in itself and not represented here, arranged to power the coil.

The brake 1 also comprises a rotor 7 of annular form which is received in the groove 4 to pivot about the axis 5. The rotor 7 is of ferromagnetic material. The rotor 7 is linked by a movement transmission chain to the control instrument. In the example described here, the transmission chain comprises a gear train having a multiplying ratio such that a pivoting of ten or so degrees of the control instrument generates several revolutions of the rotor 7.

When the control coil 3 is subjected to an excitation current, it generates magnetic fluxes passing from the poles 6.1 to the poles 6.2, or in the reverse direction, passing through the groove 4 and therefore the rotor 7 in which these fluxes induce local magnetic fields. Thus, in the rotor 7, each flux has a path direction having a radial component and a circumferential component. In the case of an abrupt outage of the excitation when the rotor is immobile, a remanent field is created locally in the rotor at each point where a magnetic flux has circulated and has a direction identical to that of the flux.

The brake 1 comprises at least one magnet 8 mounted on the stator 2 facing the rotor 7 and having a sufficient power to locally generate, in the rotor 7, a level of induction substantially equal to a maximum level of induction generated by the coil when the latter is powered.

More specifically, the brake comprises a magnet 8.1 fixed between two poles 6.1 adjacent to one another and a magnet 8.2 fixed between two poles 6.2, one of which is located facing the magnet 8.1. The magnets are positioned substantially facing one another, notwithstanding an angular offset corresponding to the angular offset between the poles 6.1, 6.2. The magnets 8 are polarized so as to generate a radial magnetic flux which passes through the rotor 7 in a direction having a radial component and a circumferential component just like the flux generated by the control coil 3 when it passes through the rotor 7 at the same point.

As can be better seen in FIG. 3, the flux generated by the magnets 8 will make the local magnetic fields which have been created in the rotor 7 all be oriented in the same direction, eliminating the cogging effect.

Obviously, the invention is not limited to the embodiments described, but encompasses any variant falling within the scope of the invention as defined by the claims.

In particular, the brake can comprise a single magnet or, on the contrary, several magnets, for example distributed around the groove 4.

The brake can have a structure other than that described and represented here. The rotor can, for example, take the form of a disc or of a ring received in a groove formed in the stator.

The magnet can be mounted in the place of one of the poles of the stator.

1-5. (canceled)

6. A magnetic hysteresis brake comprising a stator equipped with at least one control coil and a rotor mounted to be mobile facing poles of the stator, the brake comprising at least one magnet mounted on the stator facing the rotor and having a sufficient power to locally generate, on the circumference of the rotor, a level of induction substantially equal to a maximum level of induction generated by the coil when the latter is powered, the rotor having an annular form and being received to pivot about its central axis in a circular groove of the stator, the groove having flanks provided with reliefs forming the poles of the stator, the brake comprising at least one magnet mounted on one of the flanks of the groove, wherein the brake comprises two magnets each mounted on one of the flanks of the groove.

7. The brake according to claim 6, wherein the magnets mounted on the flanks of the groove are positioned substantially facing one another.

8. The brake according to claim 6, wherein the at least one magnet mounted on the stator is mounted between two poles of the stator.
